(19) United States
(12) Patent Application Publication
(10) Pub. No.: US 2011/0100882 A1
(43) Pub. Date: May 5, 2011

(54) PORTABLE SOLIDS SCREENING BUCKET

(76) Inventors: Roger D. Beam, Albion, NY (US); Richard H. Beam, Albion, NY (US); Michael M. Beam, Buffalo, NY (US)

(21) Appl. No.: 12/609,038

(22) Filed: Oct. 30, 2009

(51) Int. Cl. B07B 1/28

(52) U.S. Cl. 209/252; 209/369; 209/260

(57) ABSTRACT

A solids sifting apparatus comprising a bucket assembly comprised of a back wall and a bucket framework joined to the back wall and extending forwardly therefrom. The bucket framework defines a lateral side wall comprised of a plurality of openings, and a forward perimeter defining a front opening. The apparatus is further comprised of a rotational assembly comprising a mounting fixture comprising at least one attachment feature, a rotatable driven member joined to the back wall of the bucket assembly, a rotatable driving member coupled to the rotatable driven member; and a rotary drive power source operatively connected to the rotatable driving member and joined to the mounting fixture. The mounting fixture may include attachment features. A first attachment feature may comprise an upper lip extending rearwardly and downwardly from a mating plate, with second and third attachment features comprising first and second brackets extending outwardly from the mating plate.

### BACKGROUND OF THE INVENTION

1. Field of the Invention

Transportable solids separating apparatus that is attachable to a loader, bulldozer, tractor, skid steer, earth mover, or other vehicle, for separating solids of varying sizes from each other.

2. Description of Related Art

The capability to separate mixtures of earthen solids containing fines and larger solid objects is useful. One use is in the separation of soil from rocks, roots, and other large debris after performing a ground clearing operation. Another use is in the separation of sand and other small fines from coarser gravel. Another use is in ore mining, where it is desired to separate large chunks of ore from smaller fines at or near the point of extraction from the earth.

The scale of these various operations may vary considerably. At the lower end of the scale, there is a need in the residential of commercial landscaping business to be able to separate mixtures of soil and rocks to produce fertile topsoil for spreading at the construction site, while also providing relatively clean rocks for backfill and/or drainage control at the site, or for hauling to other sites. There is a similar need in medium scale operations, such as at large commercial construction sites, or in highway construction. At the upper end of the scale, there may be a need in certain mining operations to separate ore from fines as a first step in a mineral refining process.

Various solids separators and classifiers that can separate mixtures of earthen solids are known. However, these devices are generally relatively large in scale, are not easily and cost-effectively transported, and are provided as stand-alone single-use devices. What is needed is a solids separating apparatus which is easily transported to a job site, and which is easily attached to and detached from a loader, bulldozer, tractor, skid steer, earth mover, or other mining, construction, farming, or landscaping vehicle. In that manner, the apparatus may function as one of many implements that are attachable to the vehicle, thereby minimizing the overall cost and inventory of equipment at a site, while maintaining the versatility needed to perform all of the required earth processing tasks.

### SUMMARY OF THE INVENTION

The problem of separating a portion of solid objects from a mixture of solid objects of varying sizes is addressed by providing a solids sifting apparatus comprising a bucket assembly comprised of a back wall, and a bucket framework joined to the back wall and extending forwardly therefrom, the bucket framework defining a lateral side wall comprised of a plurality of openings, and a forward perimeter defining a front opening; and means for rotating the bucket assembly relative to a mounting fixture around an axis perpendicular to the back wall of the bucket assembly. The apparatus is provided with the mounting fixture rotatably joined to the back wall of the bucket assembly for easy attachment to and operation by a utility vehicle, thereby making the apparatus highly portable between work sites.

More specifically, a solids sifting apparatus is provided comprising a bucket assembly comprised of a back wall and a bucket framework joined to the back wall and extending forwardly therefrom. The bucket framework defines a lateral side wall comprised of a plurality of openings, and a forward perimeter defining a front opening. The apparatus is further comprised of a rotational assembly comprising a mounting fixture comprising at least one attachment feature, a rotatable driven member joined to the back wall of the bucket assembly and rotatably joined to the mounting fixture, a rotatable driving member coupled to the rotatable driven member; and a rotary drive power source operatively connected to the rotatable driving member and joined to the mounting fixture.

The lateral side wall of the bucket framework may be comprised of a flat bottom wall, which may be a solids-impermeable wall. The flat bottom wall may be comprised of a tapered forward leading edge for scooping up mixtures of solids from a pile. The tapered leading edge may be arcuate, for cutting into the ground. The leading edge may include a plurality of teeth for dislodging large solid objects embedded in the ground.

The bucket framework may have a substantially rectangular shape, wherein the lateral side wall is further comprised of first and second opposed side walls, and a top wall. At least one of the first and second opposed side walls and top wall is comprised of a plurality of openings. The first and second opposed side walls and top wall may be comprised of screens. The screens may be mesh screens, perforated metal screens, gratings, or other wall structures with a plurality of openings therethrough. The front opening of the bucket framework may be partially obstructed by a retention plate joined to the framework and extending downwardly from a top edge of the forward perimeter of the front opening.

The rotary drive power source may be a hydraulic motor. The rotatable driven member may be a ring gear, and the rotatable driving member may be a pinion gear engaged with the ring gear. Alternatively, the rotatable driven member may be a driven pulley, and the rotatable driving member may be a drive pulley engaged with the driven pulley by a drive belt. The back wall of the bucket assembly and the mounting fixture of the rotational assembly may be configured to form a shroud that encloses the rotatable driven member and the rotatable driving member, thereby protecting them from exposure to dirt and debris during operation of the sifting apparatus.

The mounting fixture may include multiple attachment features. A first attachment feature may comprise an upper lip extending rearwardly and downwardly from a mating plate, with second and third attachment features comprising first and second brackets extending outwardly from the mating plate. The rear wall of the bucket assembly may be comprised of first and second engagement features, with the rotatable driven member being removably joined to the back wall by engagement with the first and second engagement features.

The sifting apparatus may be operatively connected to a pair of first and second support arms for connection to and operation by a utility vehicle, such as a skid-steer. Each of the support arms is comprised of a proximal portion, a distal portion, and a central region between the proximal portion and the distal portion. The proximal portions of the first support arm and the second support arm are each members of respective first and second three member linkages. The first and second three member linkages are further comprised of second and third members, wherein the second member of the three member linkage is the pickup fixture pivotably attached at a lower region thereof to a proximal end of the proximal portion of the support arm, and the third member of the three member linkage is comprised of a variable length linear actuator pivotably attached a proximal end thereof to an upper region of the mounting fixture and pivotably attached at a distal end thereof to the central region of the support arm.

Also according to the present disclosure, a method of separating a portion of solid objects from a mixture of solid objects of varying sizes is provided. The method comprises providing the solids sifting apparatus described herein comprising the bucket assembly and the rotational assembly, loading a quantity of the mixture of solid objects into the bucket assembly so as to partially fill the bucket assembly; tilting the bucket assembly such that the front opening is directed upwardly; and rotating the bucket assembly around the axis of rotation defined by the rotatable driven member to cause the solid objects to tumble within the bucket assembly and to cause objects having a size less than the threshold size to fall through the threshold size openings of the bucket assembly. During the separation, the bucket assembly is preferably tilted sufficiently upwardly so as to prevent any of the solid objects from being discharged from the front opening. The method may further comprise rotating the bucket assembly until substantially all of the objects having a size less than the threshold size have been discharged from the bucket assembly, and tilting the bucket assembly such that the front opening is directed downwardly, thereby causing the retained solid objects having a size greater than the threshold size to be discharged from the bucket assembly through the front opening. The mixture of solid objects may be a loose pile, and the method may be further comprised of loading the bucket by inserting a portion of the forward perimeter of the bucket assembly into the loose pile. The mixture of solid objects may be solid ground, and the method further may be further comprised of loading the bucket assembly by inserting a portion of the forward perimeter of the bucket assembly into the solid ground.

### BRIEF DESCRIPTION OF THE DRAWINGS

The present disclosure will be provided with reference to the following drawings, in which like numerals refer to like elements, and in which:

FIG. 1 is a side elevation view of the solids sifting apparatus attached to a utility vehicle;

FIG. 2 is a perspective view of the solids sifting apparatus and utility vehicle of FIG. 1;

FIG. 3 is a rear perspective view of the solids sifting apparatus;

FIG. 4A is a front exploded perspective view of the solids sifting apparatus;

FIG. 4B is a rear exploded perspective view of the solids sifting apparatus;

FIG. 5 is a front perspective view of the solids sifting apparatus attached to a utility vehicle and deployed on the ground, scooping up a mixture of solid objects;

FIG. 6 is a front perspective view of the solids sifting apparatus tilted backwards and ready to be raised into a sifting position;

FIG. 7 is a front perspective view of the solids sifting apparatus raised into a sifting position;

FIG. 8A is a front perspective view of the solids sifting apparatus during a sifting operation, rotated at about 45 degrees;

FIG. 8B is a front perspective view of the solids sifting apparatus during a sifting operation, rotated at about 90 degrees;

FIG. 8C is a front perspective view of the solids sifting apparatus during a sifting operation, rotated at about 180 degrees;

FIG. 9 is a side elevation view of the solids sifting apparatus deployed in a discharging position, dumping large solids retained in the basket into a dump truck;

FIG. 10A is a side elevation view of the solids sifting apparatus attached to the articulating arms of a utility vehicle and in the sifting position;

FIG. 10B is a side elevation view of the solids sifting apparatus attached to the articulating arms of a utility vehicle and in the retained solids discharge position;

FIG. 11A is a rear perspective view of a second embodiment of the solids sifting apparatus;

FIG. 11B is a partially exploded rear perspective view of the solids sifting apparatus of FIG. 11A;

FIG. 11C is a partially exploded front perspective view of the solids sifting apparatus of FIG. 11A;

FIG. 12A is a rear perspective view of a third embodiment of the solids sifting apparatus;

FIG. 12B is a partially exploded rear perspective view of the solids sifting apparatus of FIG. 12A; and

FIG. 12C is a partially exploded front perspective view of the solids sifting apparatus of FIG. 12A.

The present invention will be described in connection with a preferred embodiment, however, it will be understood that there is no intent to limit the invention to the embodiment described. On the contrary, the intent is to cover all alternatives, modifications, and equivalents as may be included within the spirit and scope of the invention as defined by the appended claims.

### DETAILED DESCRIPTION

For a general understanding of the present invention, reference is made to the drawings. In the drawings, like reference numerals have been used throughout to designate identical elements. In the following disclosure, the present invention is described in the context of its use as a sifting apparatus for earthen materials. However, it is not to be construed as being limited only to use in the processing of earthen solids mixtures. The invention is adaptable to any use in which the separation of mixtures of solids is desirable to be provided from a portable sifting apparatus. Additionally, the description identifies certain components with the adjectives “front,” “rear,” “top,” “upper,” “bottom,” “lower,” “left,” “right,” etc. These adjectives are provided in the context of the mounting and use of the apparatus with a utility vehicle as shown in the drawings. The description is not to be construed as limiting the apparatus to use with a particular utility vehicle. The instant apparatus may be used with utility vehicles and apparatus other than as shown and described herein.

In describing the present invention, a variety of terms are used in the description. As used herein, the term “earthen solids” is meant to indicate solids that are derived from the earth, including but not limited to rocks, soil, sand, gravel, roots, decayed vegetation, ores, and other naturally occurring materials. Earthen solids may also include man-made solids, such as chunks of concrete or other aggregates, ground-up asphalt pavement, and the like. As used herein, the term “solids mixture” is meant to indicate a mixture of solids that will flow and tumble when placed within a container that is rotating around a non-vertical axis. Solids mixtures may include earthen solids and non-earthen solids.

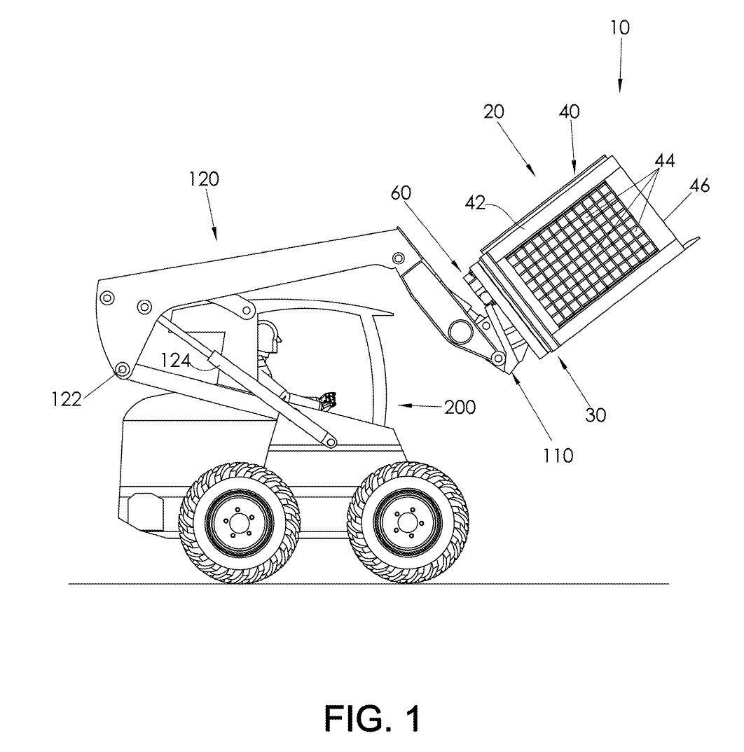

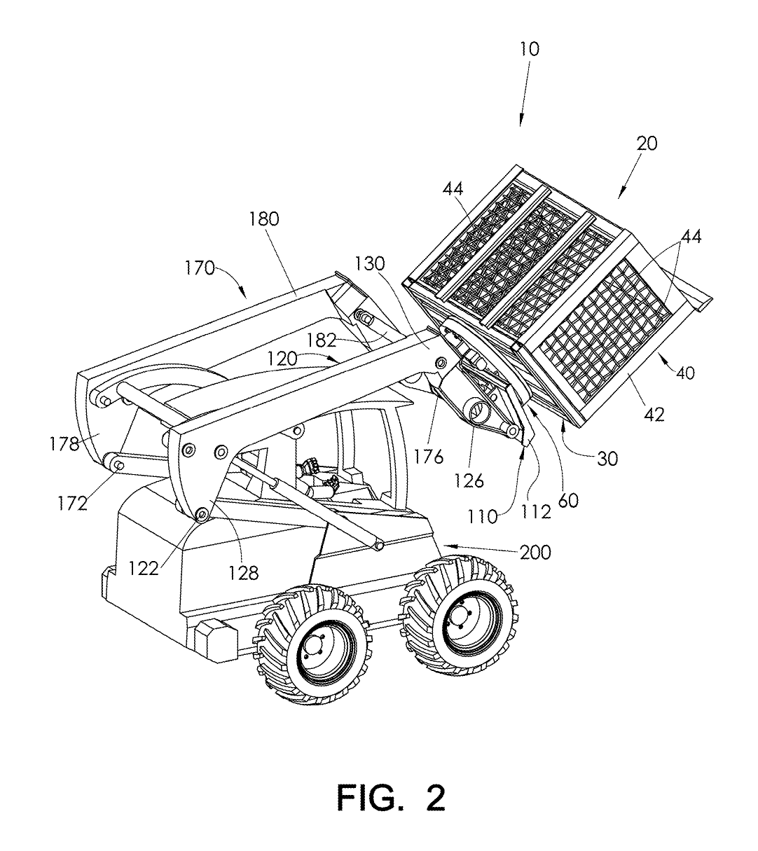

FIG. 1 is a side elevation view of the solids sifting apparatus attached to a utility vehicle, and FIG. 2 is a perspective view of the solids sifting apparatus and vehicle of FIG. 1. The apparatus 10 may be operatively connected to a pair of support arms 120 and 170, which are pivotably joined to a utility vehicle 200 at pins 122 and 172. The support arms 120 and 170 are operated by respective variable length linear actuators so as to raise and lower the apparatus 10 during its operation. (Only the first actuator 124 is visible in the views of the drawings, with the second linear actuator being on the opposite side of the vehicle 200.) The variable length linear actuators may be hydraulic cylinders.

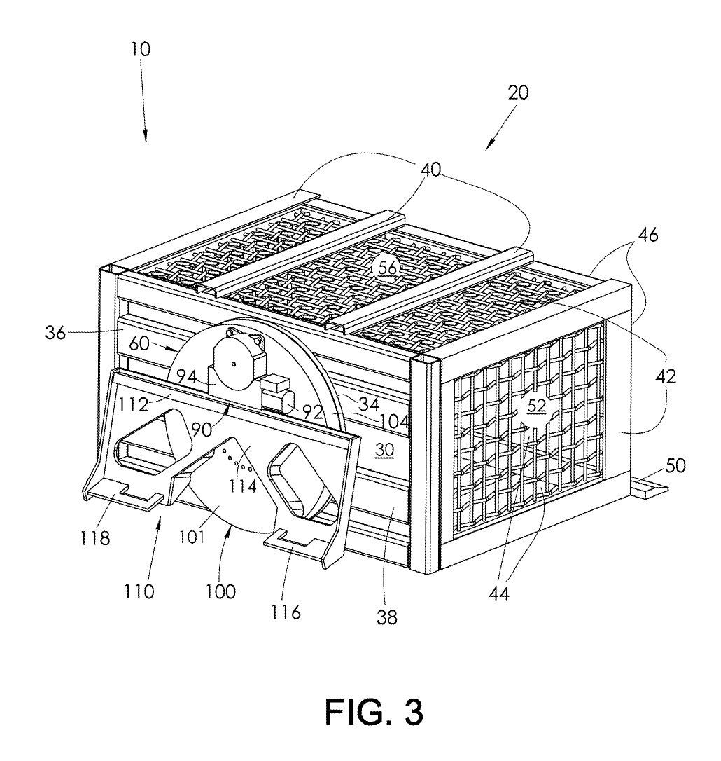

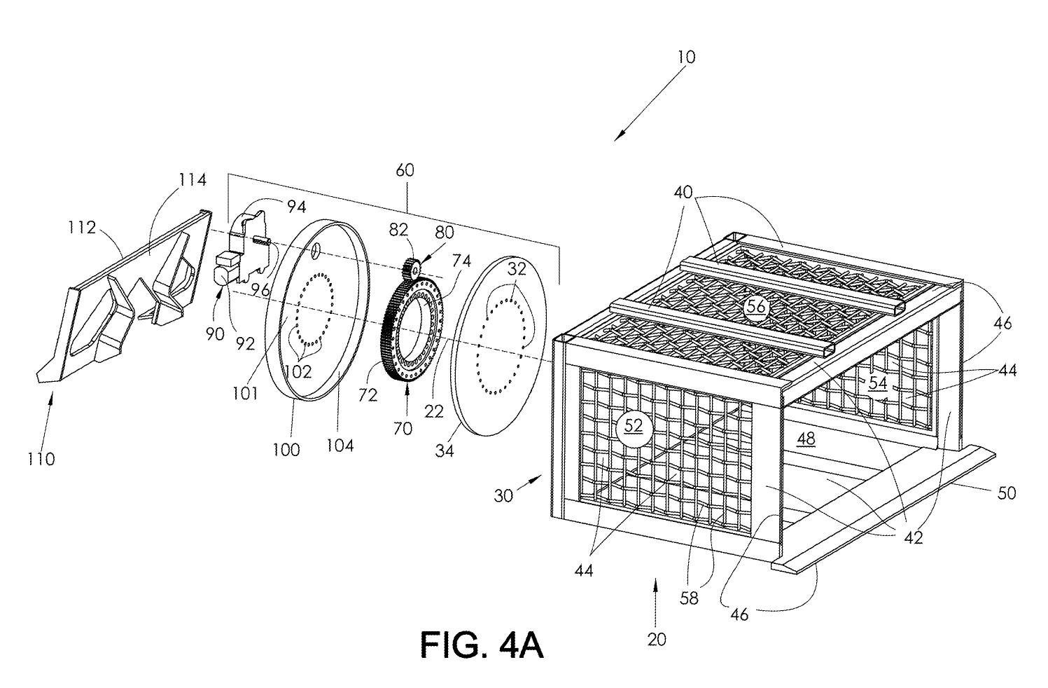

Referring also to FIGS. 3-4B, and in one embodiment depicted therein, the solids sifting apparatus 10 is comprised of a bucket assembly 20 including a back wall 30 and a bucket framework 40 joined to the back wall 30 and extending forwardly therefrom. The bucket framework 40 defines a lateral side wall 42 comprised of a plurality of openings 44, and a forward perimeter 46 defining a front opening. The lateral side wall 42 and the forward opening that it defines may have a variety of shapes, including but not limited to square, rectangular, triangular, polygonal, cylindrical, and elliptical.

The lateral side wall 42 of the bucket framework 40 may be comprised of a flat bottom wall 48, so as to enable scraping along a flat surface and/or making flat-bottomed excavations. The bottom wall 48 may be a solids-impermeable wall without openings, so that when lifting and transporting of a scoop of solids mixture to a sifting location, substantially no solids are lost through the bottom wall 48. The flat bottom wall 48 may be comprised of a tapered forward leading edge or blade 50 for scooping up mixtures of solids from a pile. The tapered leading edge 50 may be linear as shown particularly in FIG. 4A, or the leading edge 50 may be arcuate like a spade shovel edge, for cutting into the ground. The leading edge 50 may include a plurality of teeth (not shown) extending forwardly for dislodging solid objects embedded in the ground.

The bucket framework 40 may have a substantially rectangular shape as shown particularly in FIGS. 3-4B, wherein the lateral side wall 42 is further comprised of first and second opposed side walls 52 and 54, and a top wall 56. At least one of the first and second opposed side walls 52/54 and top wall 56 is comprised of a plurality of openings 44. The first and second opposed side walls 52/54 and top wall 56 (and also the bottom wall 48) may be comprised of screens. The screens may be mesh screens as shown in FIGS. 3-4B and comprised of interwoven bars; or the screens may be perforated sheet, gratings, or other wall structures with a plurality of openings therethrough. Such screen walls may be used in bucket configurations other than rectangular.

For robust operation in excavation work, the back wall 30 and bucket framework 40 are preferably made of sturdy structural materials such as steel or aluminum, provided as plate or structural shapes such as bars, rods, L′s, channels, tubing, I-beams, and the like. The joining of the back wall 30 and bucket framework 40 may be by welding or by suitable fasteners such as bolts or rivets (not shown). The screens are also preferably made of steel or aluminum, but may be made of high strength, high-impact plastics or composites.

The apparatus is further comprised of a rotational assembly 60, and means for rotating the bucket assembly 20 relative to a mounting fixture 100 around an axis perpendicular to the back wall 30 of the bucket assembly 20. The means for rotating the bucket assembly 20 may be comprised of a rotatable driven member 70 joined to the back wall 30 of the bucket assembly 20 and rotatably joined to the mounting fixture 100, a rotatable driving member 80 coupled to the rotatable driven member 70; and a rotary drive power source 90 operatively connected to the rotatable driving member 80 and joined to the mounting fixture 100.

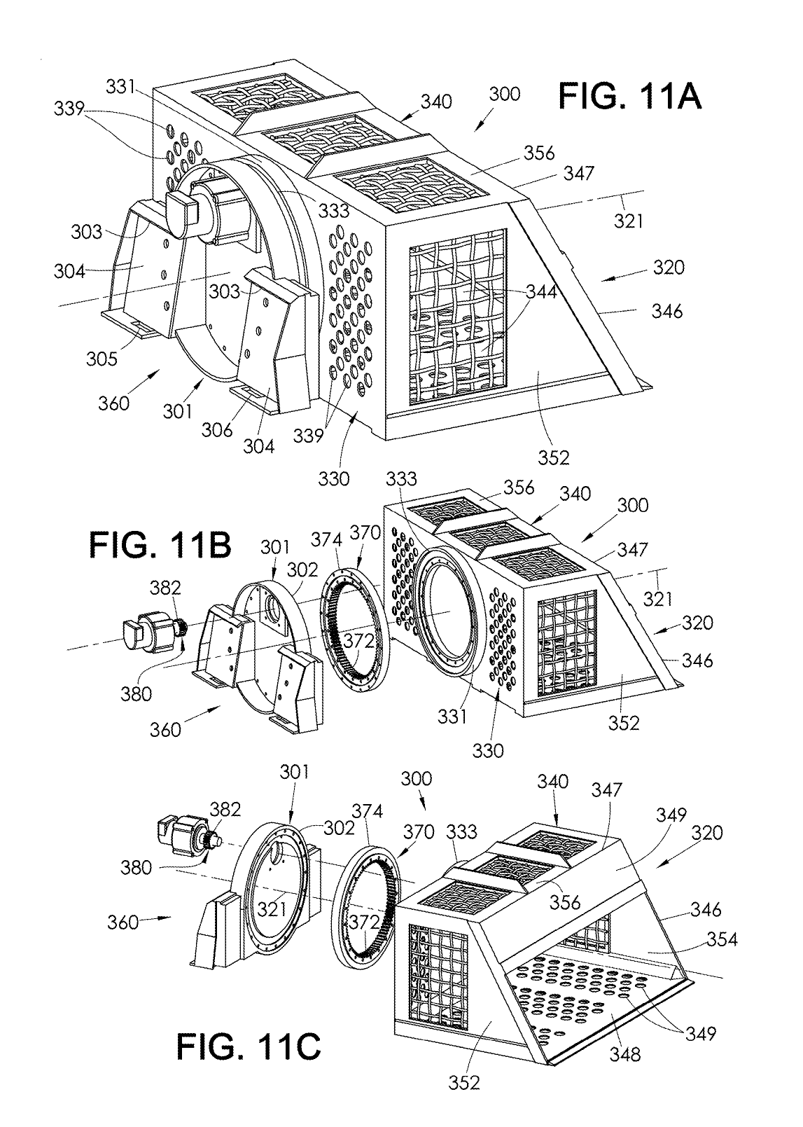

In the embodiment shown in FIGS. 4A and 4B, the rotatable driven member 70 is comprised of a ring gear 72, and the rotatable driving member 80 is a pinion gear 82 engaged with the ring gear 72. The ring gear 72 may have external teeth, with the pinion gear 82 being disposed and engaged externally with the ring gear 72. Referring to FIGS. 11B and 11C, alternatively, a ring gear 372 may be provided that has internal teeth, with a pinion gear 382 being disposed and engaged internally with the ring gear 372.

In one embodiment, the driven member 70 may be a slewing ring and turntable bearing assembly manufactured and sold by the Kaydon Corporation of Ann Arbor, Mich. Such assemblies are suitable for high stress rotational motion, such as occurs in construction equipment, and thus serve to rotatably join the rotatable driven member 70 to the mounting fixture 100 such that rotational motion of the rotatable driven member 70 relative to the mounting fixture 100 can occur. The ring and bearing assembly may include a bearing ring 74 and ring gear 72, with bearing members such as balls or rollers (not shown) disposed between them. The bearing ring 74 may be provided with a plurality of through holes, which are aligned with a corresponding plurality of through holes 102 in mounting fixture 100. The bearing ring 74 is joined to the mounting fixture 102 by suitable fasteners (not shown) that are disposed in and/or through their respective through holes.

In like manner, the ring gear 72 may be provided with a plurality of through holes, which are aligned with a corresponding plurality of through holes 32 in a mounting plate 34 that is joined to the back wall 30 of the bucket assembly 20. The ring gear 72 is joined to the mounting plate 34 by suitable fasteners (not shown) that are disposed in and/or through their respective through holes. The back wall 30 may include structural members 36 and 38, to which the mounting plate 34 is joined by suitable means such as welding, or by fasteners such as bolts (not shown).

In the embodiment depicted in FIGS. 11B AND 11C, an alternative slewing ring and turntable bearing assembly may be provided wherein the ring gear 372 is an internal ring gear, and the bearing ring 374 is external to the ring gear 372. The ring gear 372 may be joined directly to the back wall 330 of the bucket assembly. A mounting flange 331 may be provided for joining the ring gear 372 to the back wall 330.

In the embodiment of the sifting apparatus 10 depicted in FIGS. 3-4B, a substantially circular mounting plate 34 is provided, which is dimensioned to fit closely within a lip 104 that is formed on the mounting plate 100. Alternatively, the circular mounting plate may be made larger than the mounting plate 100, and may be provided with the lip that encloses the mounting plate 100. In that manner, the pinion gear 82, ring gear 72, bearing ring 74, and the bearings contained therein are protected during use from exposure to dirt, sand, and other abrasive materials. A seal (not shown) may be provided between the mounting plates 100 and 34 to further exclude such materials.

Other configurations of rotatable driven member 70 and rotatable drive member 80 are contemplated. In one embodiment (not shown), the rotatable driven member 70 may be a driven pulley, and the rotatable driving member 80 may be a drive pulley engaged with the driven pulley by a drive belt. In another embodiment (not shown), the rotatable driven member may be the mounting plate 34 or other member that is joined to the back wall 30 of the bucket assembly; and the rotatable drive member may be a member that is joined to the mounting plate 34 and operatively connected to an actuator that is operatively connected to the mounting fixture 100. For example, one or more hydraulic cylinders may be provided as actuators that are connected to the mounting plate 34 and mounting fixture 100, so as to provide oscillating rotary motion of the bucket assembly 20 relative to the mounting fixture 100. Such a configuration is preferably configured to provide at least about 180 degrees of rotation (i.e., 90 degrees clockwise from horizontal, and 90 degrees counterclockwise from horizontal), which is adequate to provide sifting of a solids mixture within the bucket assembly.

Referring again to FIGS. 3-4B, the rotary drive power source 90 may include a hydraulic motor 92. (For the sake of simplicity of illustration, the hydraulic conduits in communication with the hydraulic motor 92 are not shown.) By way of example, the hydraulic motor may be a model VIS 30 Series motor manufactured and sold by the Eaton Corporation of Eden Prairie, Minn. Other motors, such as an electric motor may be suitable. The rotary drive power source 90 may further include a worm gear drive 94 joined to the mounting plate 100 and having a stub output shaft 96, to which the rotatable drive member 80 is joined or mounted. The worm drive 94 and relative ratio of the rotatable drive member 80 and rotatable driven member 70 provide substantial speed reduction and torque multiplication of the motor 92 for rotating the bucket assembly 20. Alternatively, the hydraulic motor may directly operate the rotatable driven member 70, such as a pinion gear 382, as shown in FIGS. 11B and 11C.

The mounting fixture 100 may further include a pickup fixture 110 joined to the mounting fixture plate 101. The pickup fixture 110 may include the at least one attachment feature for attachment to a utility vehicle 200. Although in FIGS. 4A and 4B, the pickup fixture 110 and the mounting fixture 100 are shown as separate parts, they may be formed as a single unitary part. In the embodiment shown in FIGS. 3-4B, the pickup fixture 110 is comprised of a first attachment feature formed as an upper lip 112 extending rearwardly and downwardly from a mating plate 114. Second and third attachment features 116 and 118 are formed as brackets.

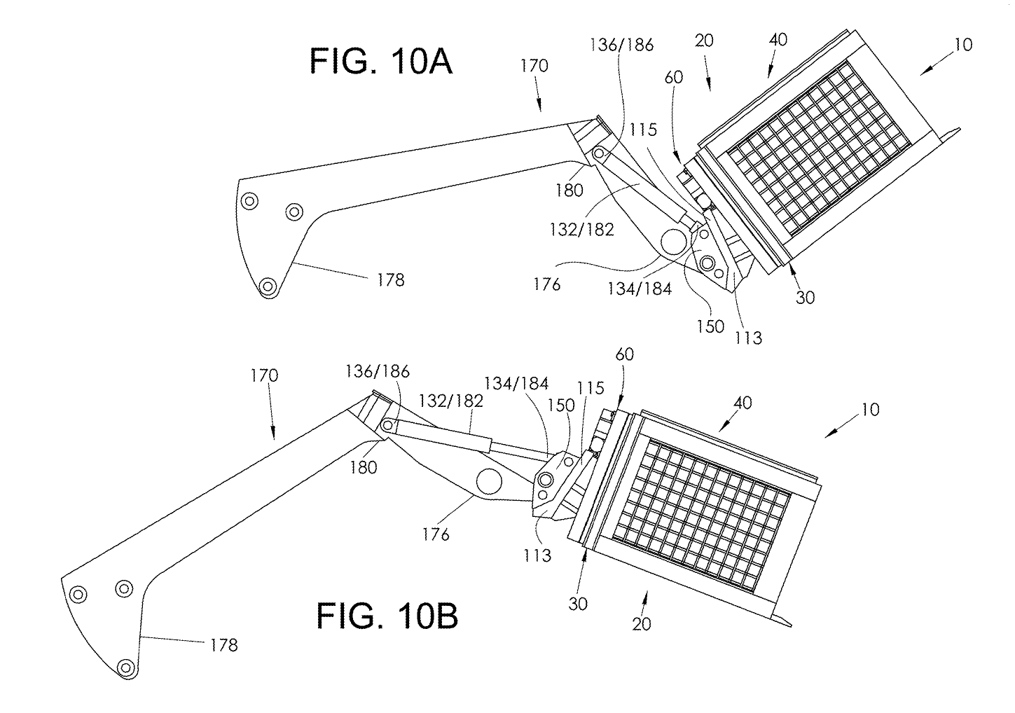

When connection of the apparatus 10 to a utility vehicle is desired, a mounting adapter 150 (see FIGS. 10A and 10B) is provided on the utility vehicle comprising a plate with an angled upper edge which may be engaged under the lip 112. The plate of the adapter is disposed against the mating plate 114, and latches (not shown) are engaged with the brackets 116 and 118. The latches may be operated by hydraulic cylinders, solenoids, or other suitable means. This configuration is a standardized attachment configuration for connection to utility vehicle articulating lifting arms 120 and 170 and mounting adapter 150 (FIGS. 10A and 10B) that are used in the construction industry. In that manner, the pickup fixture 110 of the apparatus 10 is easily removably joined to a utility vehicle 200, thereby making the apparatus 10 interchangeable with other attachments and highly portable between work sites.

The sifting apparatus 10 may be operatively connected to a pair of first and second support arms 120 and 170 for connection to and operation by a utility vehicle 200, such as a skid-steer. This is best understood with reference to FIG. 2 and FIGS. 10A and 10B, which for the sake of clarity of illustration, shows only the support arm 170. Each of the support arms 120 and 170 is comprised of a respective proximal portion 126/176, a distal portion 128/178, and a central region 130/180 between the proximal portion 126/176, and the distal portion 128/178. The proximal portions 126/176 of the first support arm 120 and the second support arm 170 are each members of respective first and second three member linkages.

The first and second three member linkages are further comprised of second and third members. The second member of the first three member linkage is the pickup fixture 110 pivotably attached at a lower region 113 thereof to a proximal end of the proximal portion 126 of the first support arm 120, and the third member of the first three member linkage is comprised of a variable length linear actuator 132 pivotably attached a proximal end 134 thereof to an upper region 115 of the pickup fixture 110 and pivotably attached at a distal end 136 thereof to the central region 130 of the support arm 120. The second member of the second three member linkage is the pickup fixture 110 pivotably attached at the lower region 113 thereof to a proximal end of the proximal portion 176 of the second support arm 170, and the third member of the second three member linkage is comprised of a variable length linear actuator 182 pivotably attached a proximal end 184 thereof to the upper region 114 of the pickup fixture 110 and pivotably attached at a distal end 186 thereof to the central region 180 of the support arm 170.

In the embodiment shown in FIGS. 10A and 10B, the first and second support arms 120 and 170 are connected to a mounting adapter 150, which is joinable to the pickup fixture 110. The mounting adapter 150 may be a standardized mounting adapter as described previously that is used in the construction industry for quick-change of various utility attachments. Alternatively, the pickup fixture 110 may be joined directly to the lifting arms 120 and 170 at its lower region 113, and to the variable length linear actuators 132 and 182 at its upper region 115.

The variable length linear actuators 132/182 may be hydraulic cylinders. When the actuators 132/182 are retracted as shown in FIG. 10A, the apparatus 10 is in the sifting position, ready to be rotated. When the actuators 132/182 are extended as shown in FIG. 10B, the apparatus 10 is in the dumping position for discharging large retained solid objects from the bucket assembly 20.

FIG. 11A-11C are perspective views of a second embodiment of the solids sifting apparatus, the latter two of which are partially exploded. The solids sifting apparatus 300 is similar to the apparatus 10 of FIGS. 3-4B, and is comprised of a bucket assembly 320 including a back wall 330 and a bucket framework 340 joined to the back wall 330 and extending forwardly therefrom. The apparatus 300 is further comprised of a rotational assembly 360, and means for rotating the bucket assembly 320 relative to a mounting fixture 301 around an axis 321 perpendicular to the back wall 330 of the bucket assembly 320.

The bucket framework 340 defines a lateral side wall comprised of a plurality of openings, and a forward perimeter 346 defining a front opening. The lateral side wall of the bucket framework 340 may be comprised of a flat bottom wall 348, which may be a solids-impermeable wall without openings. Alternatively, the bottom wall 348 may include a plurality of openings 349, and/or the back wall 330 may include a plurality of openings 339, both of which may serve to increase the screening rate during operation of the apparatus 300.

The bucket framework 340 may have a substantially rectangular shape. Alternatively, the framework 340 may have a trapezoidal shape, wherein the lateral side wall is further comprised of first and second opposed trapezoidal side walls 352 and 354, and a top wall 356. At least one of the first and second opposed side walls 352/354 and top wall 356 is comprised of a plurality of openings 344. The first and second opposed side walls 352/354 and top wall 356 (and also the bottom wall 348 and back wall 330) may be comprised of screens. The screens may be mesh screens comprised of interwoven bars; or the screens may be perforated sheet, gratings, or other wall structures with a plurality of openings therethrough. In one embodiment, the screens are made easily removable by the use of suitable retainers/fasteners, so that screens of varying sized openings may be quickly interchanged. In that manner, sifting of a variety of materials at various desired threshold sizes may be performed by one sifting apparatus 300, possibly in a sequence of size stages.

The front opening of the bucket framework 340 may be partially obstructed by a retention plate 349 joined to the framework 340 and extending downwardly from the top edge 347 of the forward perimeter of the front opening. In that manner, when the sifting apparatus 300 is operated, tumbling solid materials are directed toward the back wall 330 of the bucket assembly 320, thereby preventing the solids from spilling out of the front opening.

The back wall 330 of the bucket assembly 320 and the mounting fixture 301 of the rotational assembly 360 may be configured to form a shroud that encloses the rotatable driven member 370 and the rotatable driving member 380, thereby protecting them from exposure to dirt and debris during operation of the sifting apparatus 300. Referring again to FIGS. 11A-11C, the flange 331 on the back wall 330 is provided with a lip 333, which extends rearwardly and encloses the outside diameter of the rotatable driven member 370, thereby deflecting dirt from the seal area of member 370, and extending its service life.

The mounting fixture 301 may include multiple attachment features. A first attachment feature may comprise an upper lip 303 extending rearwardly and downwardly from a mating plate 304, with second and third attachment features comprising first and second brackets 305 and 306 extending outwardly from the mating plate 304. As described previously, when connection of the apparatus 300 to a utility vehicle is desired, a mounting adapter is provided on the utility vehicle comprising a plate with an angled upper edge which may be engaged under the lip 303. The plate of the adapter is disposed against the mating plate 304, and latches are engaged with the brackets 305 and 306.

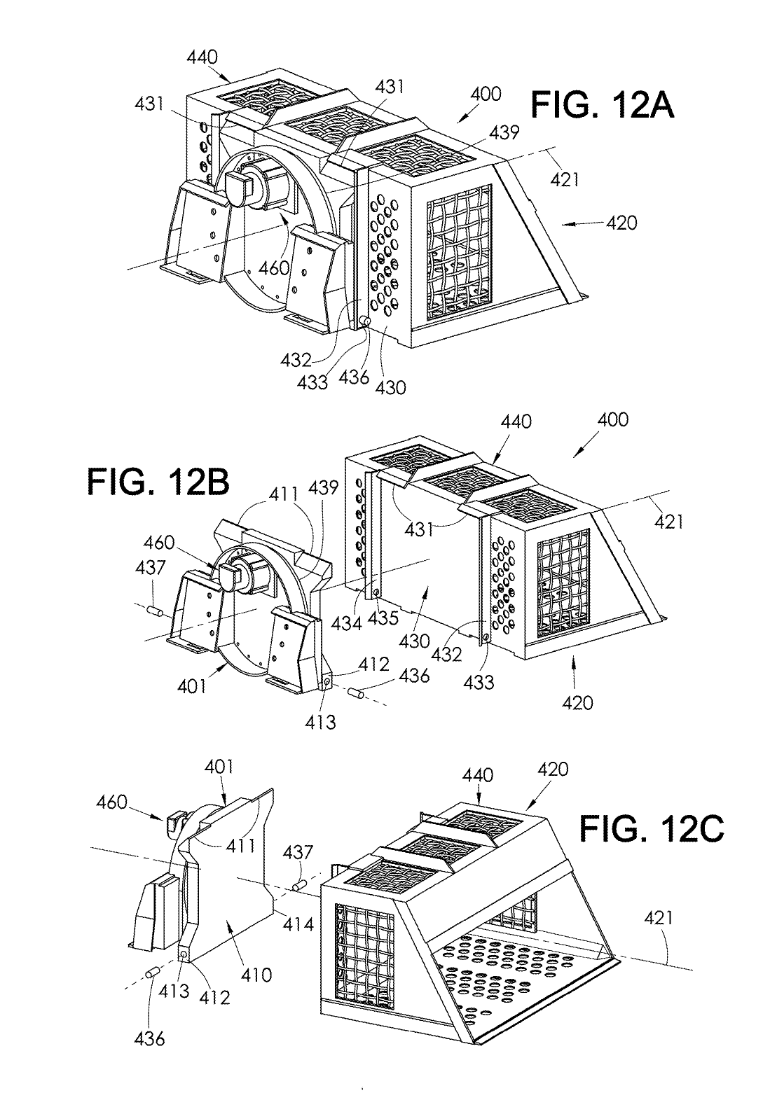

FIG. 12A-12C are perspective views of a third embodiment of the solids sifting apparatus, the latter two of which are partially exploded. The solids sifting apparatus 400 is similar to the apparatus 300 of FIGS. 11A-11C, and is comprised of a bucket assembly 420 including a back wall 430 and a bucket framework 440 joined to the back wall 430 and extending forwardly therefrom. The apparatus 400 is further comprised of a rotational assembly 460, and means for rotating the bucket assembly 420 relative to a mounting fixture 401 around an axis 421 perpendicular to the back wall 430 of the bucket assembly 420.

The main difference between the sifting apparatus 300 of FIGS. 11A-11C and the sifting apparatus 400 of FIGS. 12A-12C is that the rear wall 430 of the apparatus 400 is comprised of first and second engagement features, with the rotatable driven member (not shown, but substantially the same as member 370 of apparatus 300) being removably joined to the back wall 430 by engagement with the first and second engagement features. The first engagement feature may be comprised of an upper lip 431 extending rearwardly and downwardly from the back wall 430 of the bucket assembly 420. The second engagement feature may be comprised of a first bracket 432 including a first through hole 433. A third engagement feature may be provided comprised of a second bracket 434 including a second through hole 435.

The mounting fixture 401 is comprised of an adapter plate 410 to which is joined the flange 439. Alternatively, the flange 439 may be provided as a machined feature in the adapter plate 410. The rotational assembly 460 is substantially the same as the rotational assembly 360 of apparatus 300, and is operatively connected to the adapter plate 410 in the same manner as the rotational assembly 360 is operatively connected to the rear wall 300 of the apparatus 300. Thus the adapter plate 410 is rotatable by the rotational assembly 460. A lip is provided as in lip 333 of the apparatus 300 to exclude dirt and debris from the bearing and ring and pinion gears.

The adapter plate 410 is comprised of an angled upper edge 411, a first lower boss 412 having a bore 413 therein, and a second lower boss 414 having a bore (not shown) therein. When connection of the adapter plate 410 to the back wall 430 of the bucket assembly 420 is desired, the adapter plate 410 is disposed against the back wall 430 with the angled upper edge 411 thereof disposed under the upper lip 431 of the bucket assembly 420. Then pin 436 is disposed through hole 433 into bore 413 in boss 412, and pin 437 is disposed through hole 435 into the bore (not shown) in boss 414. The pins 436 and 437 may be inserted by hand, or by hydraulic cylinders, solenoids, or other suitable means (not shown).

In that manner, the rotating assembly 401 is easily connectable and disconnectable to the bucket assembly, providing for quick changes between bucket assemblies having different sized threshold openings, and/or quick changes to other portable rotating bucket devices, such as portable cement mixers and the like.

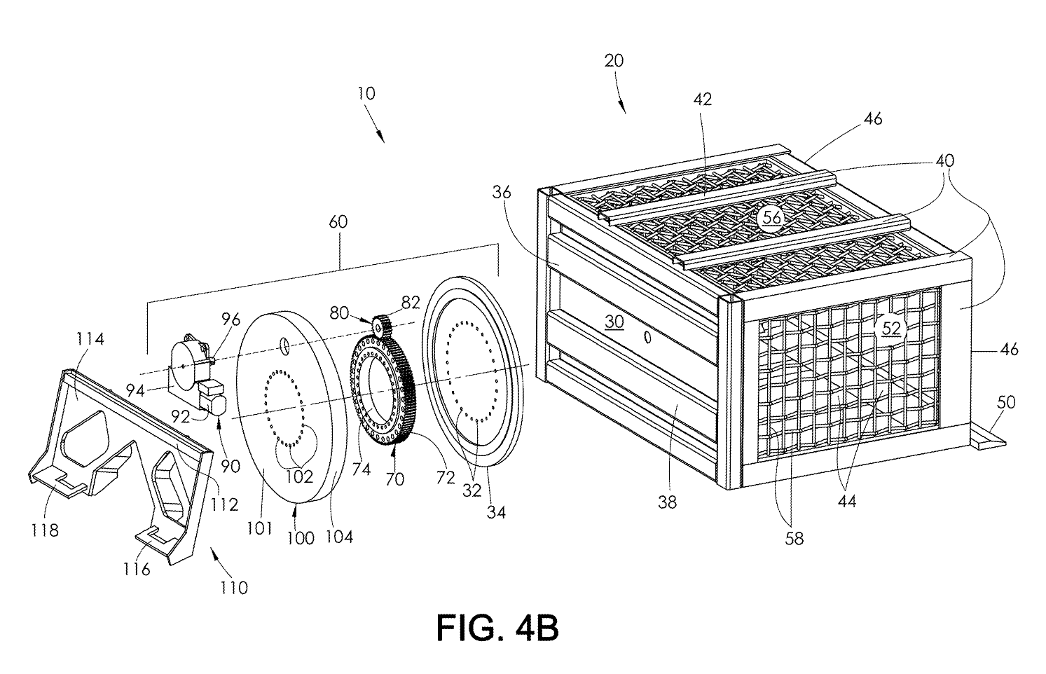

Also according to the present disclosure, a method of separating a portion of solid objects from a mixture of solid objects of varying sizes using the instant apparatus 10, 300, or 400 is provided. This is best understood with reference to FIGS. 5-9, which show the apparatus 10 in operation. It is to be understood that although the sifting apparatus 10 is depicted in the operations shown in FIGS. 5-9, the second and third sifting apparatus 300 and 400 could be substituted.

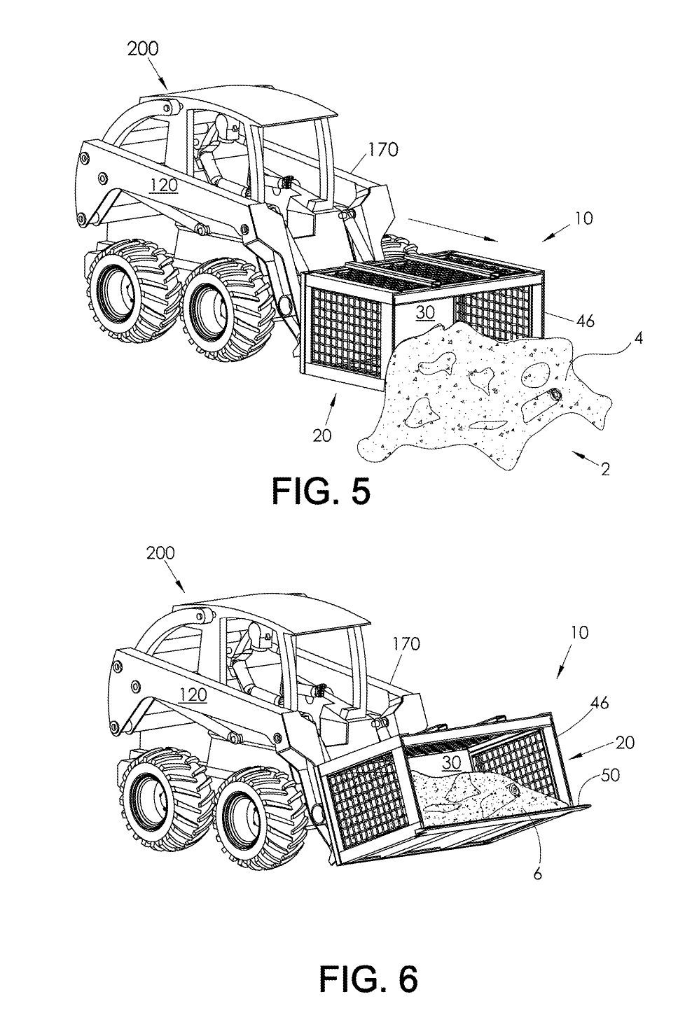

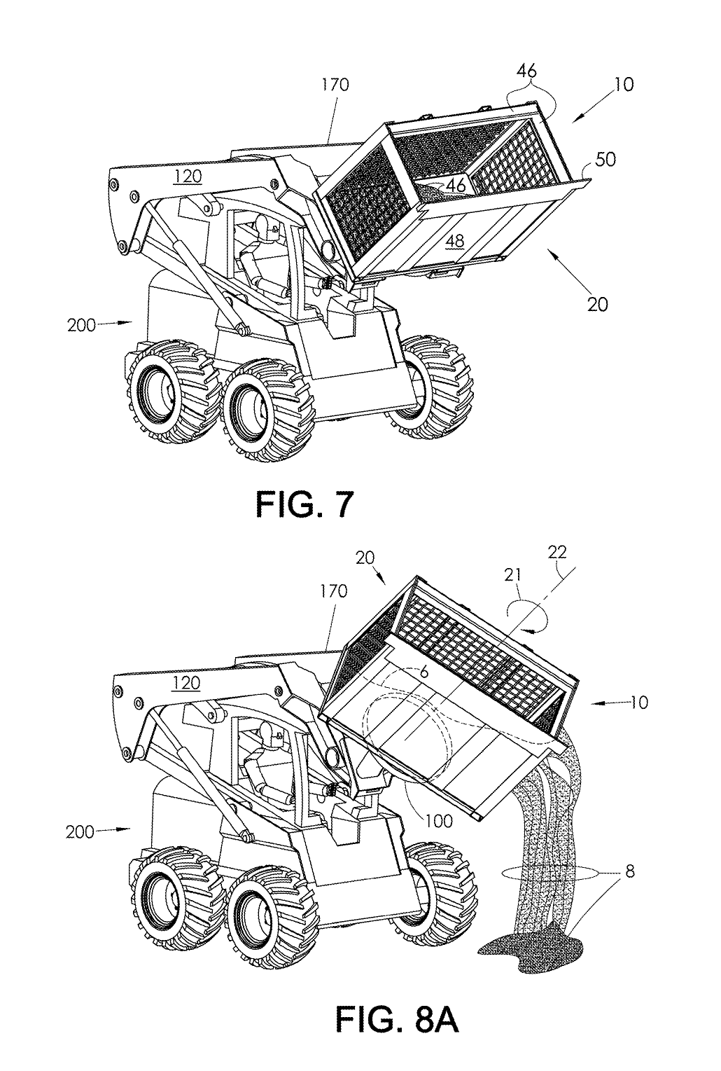

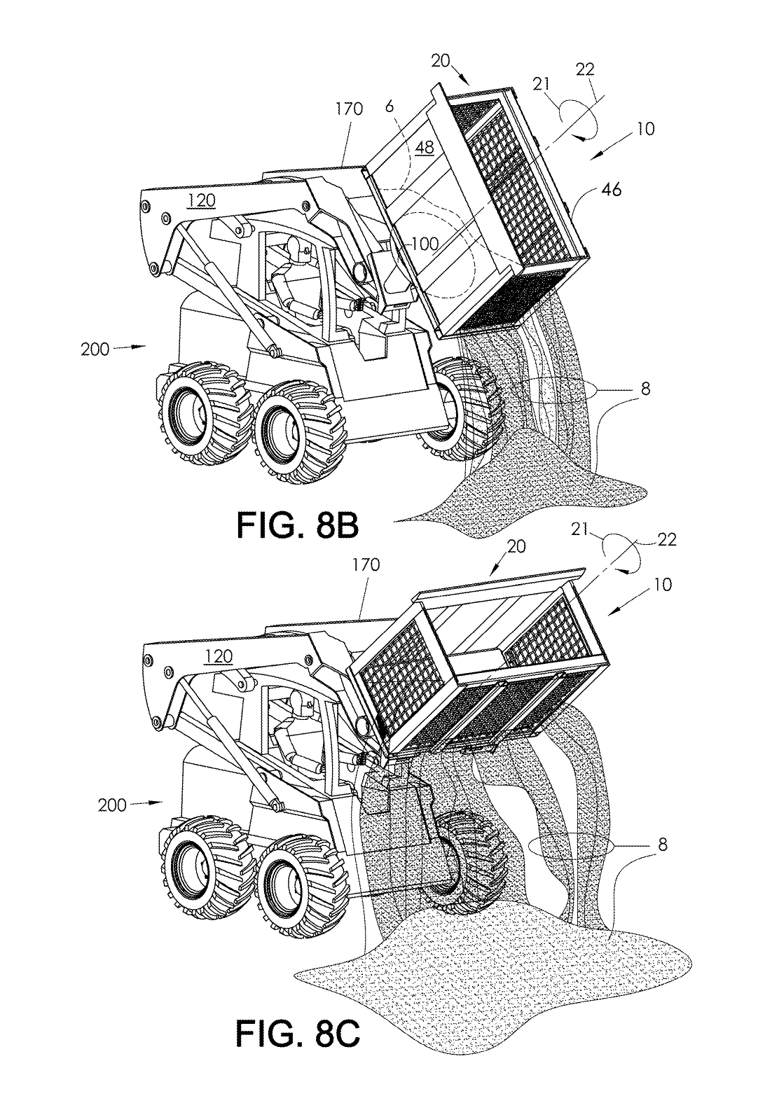

The method comprises loading a quantity of a mixture 2 of solid objects into the bucket assembly 20, either by ramming a pile 4 as shown in FIG. 5, or by forcing the blade 50 of the bucket assembly 20 into the ground, so as to partially fill the bucket assembly 20. The bucket assembly 20 is then tilted such that the front opening defined by the forward perimeter 46 is directed upwardly, both by retracting the actuators 132/182 as shown in FIG. 10A, and by raising the bucket assembly 20 as shown in FIGS. 6 and 7. Referring to FIGS. 8A-8C, the bucket assembly is then rotated as indicated by arrow 21 around the axis of rotation 22 defined by the rotatable driven member 70 (see also FIG. 4A), thereby causing the solid objects 6 within the bucket assembly 20 to tumble, and to cause objects 8 having a size less than the threshold size to fall through the threshold size openings of the bucket assembly. During the separation, the bucket assembly is preferably tilted sufficiently upwardly so as to prevent any of the solid objects 6 from being discharged from the front opening. The bucket assembly 20 is only partially filled at the start of the process, so that objects will not be discharged from the front opening, but will also tumble within it as it is rotated.

The bucket assembly 20 may be continuously rotated in one direction as indicated by arrow 21; or the rotation of the bucket assembly 20 may alternated between a first direction 21, and the opposite direction. The rotational assembly 60 may be provided such that it has less than 360 degrees of rotational displacement; for example, nearly 180 degrees in a first direction, and nearly 180 degrees in the opposite direction, such that the bucket assembly can be substantially fully inverted as shown in FIG. 8C. The rotational assembly 60 may also be provided with only about 90 degrees of rotation in each direction, and still achieve a satisfactory sifting operation.

The method may further comprise rotating the bucket assembly 20 until substantially all of the objects 8 having a size less than the threshold size defined by the screen openings 44 have been discharged therefrom. The small objects 8 may be discharged onto the ground as shown in FIGS. 8A-8C; this would typically be done when the objects 8 comprise topsoil to be spread. Alternatively, the small objects 8 may be discharged into a receptacle, such as a cart, wagon, or dump truck box.

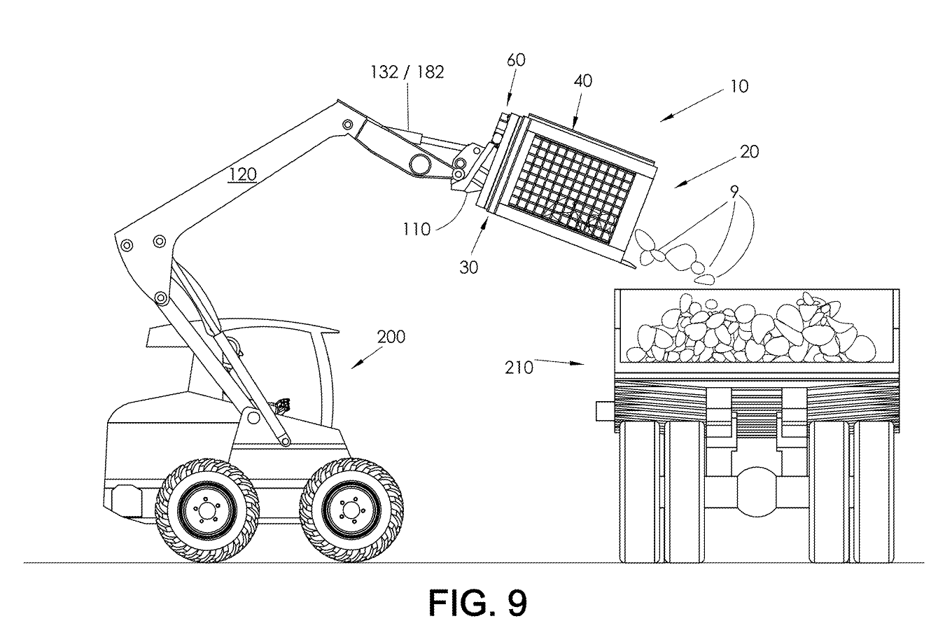

Referring to FIG. 9., the method may further comprise tilting the bucket assembly 20 such that the front opening is directed downwardly, thereby causing the retained solid objects 9 having a size greater than the threshold size to be discharged from the bucket assembly 20 through the front opening. The retained objects 9 may be discharged into a receptacle such as a dump truck 210.

It is, therefore, apparent that there has been provided, in accordance with the present invention, an apparatus and method for separating a portion of solid objects from a mixture of solid objects of varying sizes. Having thus described the basic concept of the invention, it will be apparent to those skilled in the art that the foregoing detailed disclosure is intended to be presented by way of example only, and is not limiting. Various alterations, improvements, and modifications will occur and are intended to those skilled in the art, though not expressly stated herein.

These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims.

We claim:

1. A solids sifting apparatus comprising:
a. a bucket assembly comprised of:
i. a back wall; and
ii. a bucket framework joined to the back wall and extending forwardly therefrom, the bucket framework defining a lateral side wall comprised of a plurality of openings, and a forward perimeter defining a front opening;
b. a rotational assembly comprising:
i. a mounting fixture comprising at least one attachment feature;
ii. a rotatable driven member joined to the back wall of the bucket assembly and rotatably joined to the mounting fixture;
iii. a rotatable driving member coupled to the rotatable driven member; and
c. a rotary drive power source operatively connected to the rotatable driving member and joined to the mounting fixture.

2. The sifting apparatus of claim 1, wherein the lateral side wall of the bucket framework is comprised of a flat bottom wall.

3. The sifting apparatus of claim 2, wherein the flat bottom wall is a solids-impermeable wall.

4. The sifting apparatus of claim 2, wherein the flat bottom wall is comprised of a tapered forward leading edge.

5. The sifting apparatus of claim 2, wherein the lateral side wall is further comprised of first and second opposed side walls, and a top wall, and at least one of the first and second opposed side walls and top wall is comprised of a plurality of openings.

6. The sifting apparatus of claim 5, wherein the first and second opposed side walls and top wall are comprised of screens.

7. The sifting apparatus of claim 1, wherein the back wall of the bucket assembly and the mounting fixture of the rotational assembly are configured to form a shroud that encloses the rotatable driven member and the rotatable driving member.

8. The sifting apparatus of claim 1, wherein the rotatable driven member is a ring gear, and the rotatable driving member is a pinion gear engaged with the ring gear.

9. The sifting apparatus of claim 1, wherein the at least one attachment feature of the mounting fixture is comprised of an upper lip extending rearwardly and downwardly from a mating plate, and first and second brackets extending outwardly from the mating plate.

10. The sifting apparatus of claim 1, wherein the rear wall of the bucket assembly is comprised of first and second engagement features, and the rotatable driven member is removably joined to the back wall by engagement with the first and second engagement features.

11. The sifting apparatus of claim 1, wherein the front opening of the bucket framework is partially obstructed by a retention plate joined to the framework and extending downwardly from a top edge of the forward perimeter of the front opening.

12. A solids sifting apparatus comprising:
a. a bucket assembly comprised of a back wall, and a bucket framework joined to the back wall and extending forwardly therefrom, the bucket framework defining a lateral side wall comprised of a plurality of openings, and a forward perimeter defining a front opening;
b. a mounting fixture comprising at least one attachment feature; and
c. means for rotating the bucket assembly relative to the mounting fixture around an axis perpendicular to the back wall of the bucket assembly.

13. The sifting apparatus of claim 12, wherein the means for rotating the bucket assembly is comprised of a rotatable driven member joined to the back wall of the bucket assembly and rotatably joined to the mounting fixture; a rotatable driving member coupled to the rotatable driven member; and a rotary drive power source operatively connected to the rotatable driving member and joined to the mounting fixture.

14. The sifting apparatus of claim 13, wherein the rotatable driven member is a ring gear, and the rotatable driving member is a pinion gear engaged with the ring gear.

15. A method of separating a portion of solid objects from a mixture of solid objects of varying sizes, the method comprising:
a. providing a solids sifting apparatus comprising:
i. a bucket assembly comprised of a back wall; and a bucket framework joined to the back wall and extending forwardly therefrom, the bucket framework defining a lateral side wall comprised of a plurality of threshold size openings, and a forward perimeter defining a front opening;
ii. a rotational assembly comprising a mounting fixture comprising at least one attachment feature; a rotatable driven member joined to the back wall of the bucket assembly, and rotatably joined to the mounting fixture, and defining an axis of rotation of the bucket assembly; a rotatable driving member coupled to the rotatable driven member; and a rotary drive power source operatively connected to the rotatable driving member and joined to the mounting fixture;
b. loading a quantity of the mixture of solid objects into the bucket assembly so as to partially fill the bucket assembly;
c. tilting the bucket assembly such that the front opening is directed upwardly; and
d. rotating the bucket assembly around the axis of rotation to cause the solid objects to tumble within the bucket assembly and to cause objects having a size less than the threshold size to fall through the threshold size openings of the bucket assembly.

16. The method of claim 15, wherein the bucket assembly is tilted sufficiently upwardly so as to prevent any of the solid objects from being discharged from the front opening.

17. The method of claim 15, further comprising rotating the bucket assembly until substantially all of the objects having a size less than the threshold size have been discharged from the bucket assembly.

18. The method of claim 17, further comprising tilting the bucket assembly such that the front opening is directed downwardly, and causing the solid objects having a size greater than the threshold size to be discharged from the bucket assembly through the front opening.

19. The method of claim 15, wherein the mixture of solid objects is a loose pile, and the method further comprises loading the bucket by inserting a portion of the forward perimeter of the bucket assembly into the loose pile.

20. The method of claim 15, wherein the mixture of solid objects is solid ground, and the method further comprises loading the bucket by inserting a portion of the forward perimeter of the bucket assembly into the solid ground.
